(19) United States
(12) Patent Application Publication
(10) Pub. No.: US 2025/0293299 A1
(43) Pub. Date: Sep. 18, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Hongryeol PARK, Yongin-si (KR); HYUNBONG CHOI, Yongin-si (KR); Sangwoo PARK, Yongin-si (KR); Sohee KIM, Yongin-si (KR); Yeji YANG, Yongin-si (KR); Dasol JUN, Yongin-si (KR); SANGHOON KIM, Yongin-si (KR)

(21) Appl. No.: 18/807,544

(22) Filed: Aug. 16, 2024

(30) Foreign Application Priority Data
Mar. 12, 2024 (KR) 10-2024-0034694

(51) Int. Cl. H01M 10/0567; H01M 4/02; H01M 4/58; H01M 10/052; H01M 10/0569

(52) U.S. Cl. CPC H01M 10/0567; H01M 4/5825; H01M 10/052; H01M 10/0569; H01M 2004/028; H01M 2300/004

(57) ABSTRACT

An electrolyte and a rechargeable lithium battery including the electrolyte are provided. The rechargeable lithium battery includes a positive electrode that includes a positive electrode active material, a negative electrode that includes a negative electrode active material, and an electrolyte. The electrolyte includes a nitrile-based additive. The positive electrode active material includes at least one selected from among compounds represented by Liₐ₁Feₓ₁B¹_{y1}PO_{4-b1} and Liₐ₂Mn_{z2}Feₓ₂B¹_{y2}PO_{4-b2}, where B¹ is at least one element selected from among Ti, Mg, V, and Nb.

### CROSS-REFERENCE TO RELATED APPLICATION

The present application claims priority to and the benefit of Korean Patent Application No. 10-2024-0034694, filed on Mar. 12, 2024, in the Korean Intellectual Property Office, the entire content of which is incorporated herein by reference.

### BACKGROUND

### 1. Field

One or more embodiments of the present disclosure relate to an electrolyte for a rechargeable lithium battery and a rechargeable lithium battery including the electrolyte.

### 2. Description of the Related Art

Recently, with the rapid spread and popularization of battery being used in electronic devices, such as mobile phones, laptop computers, and/or electric vehicles, there is a rapidly increasing demand for such batteries, e.g., rechargeable batteries, to have relatively high energy density and high capacity. Therefore, intensive research has been conducted to improve performance of such rechargeable batteries, e.g., rechargeable lithium batteries.

A rechargeable lithium battery includes a positive electrode, a negative electrode, and an electrolyte. The positive and negative electrodes each include an active material capable of intercalating and deintercalating of lithium ions, and electrical energy is generated due to oxidation and reduction reactions when lithium ions are intercalated and deintercalated.

### SUMMARY

One or more aspects of embodiments of the present disclosure are directed toward a rechargeable lithium battery with improved lifespan and high-temperature storage characteristics.

Additional aspects will be set forth in part in the description which follows and, in part, will be apparent from the description, or may be learned by practice of the presented embodiments of the disclosure.

According to one or more embodiments of the present disclosure, a rechargeable lithium battery may include: a positive electrode that includes a positive electrode active material; a negative electrode that includes a negative electrode active material; and an electrolyte. The electrolyte may include a nitrile-based additive. The positive electrode active material may include at least one selected from among compounds represented by Chemical Formula 1 and Chemical Formula 2.

Liₐ₁Feₓ₁B¹_{y1}PO_{4-b1} Chemical Formula 1

In Chemical Formula 1, a1, x1, y1, and b1 may be such that 0.8≤a1≤1.2, 0.9≤x1≤1.1, 0.001≤y1≤0.05, and 0<b1≤0.05.

Liₐ₂Mn_{z2}Feₓ₂B¹_{y2}PO_{4-b2} Chemical Formula 2

In Chemical Formula 2, a2, z2, x2, y2, and b2 may be such that 0.8≤a2≤1.2, 0.5≤z2≤0.9, 0.1≤x2≤0.5, 0.001≤y2≤0.05, 0<b2≤0.05, and 0.9≤z2+x2≤1.2.

In Chemical Formula 1 and Chemical Formula 2, B1 may be at least one element selected from among titanium (Ti), magnesium (Mg), vanadium (V), and niobium (Nb).

The nitrile-based additive may include a compound represented by Chemical Formula 5.

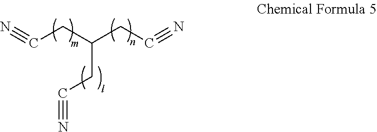

In Chemical Formula 5, l, m, and n may each independently be an integer of 0 to 10, and may be different integers from each other.

### BRIEF DESCRIPTION OF DRAWINGS

The above and other aspects, features, and advantages of certain embodiments of the present disclosure will be more apparent from the following description taken in conjunction with the accompanying drawings.

FIG. 1 illustrates a simplified conceptual diagram showing a rechargeable lithium battery according to one or more embodiments of the present disclosure.

FIGS. 2 to 5 each illustrate a simplified cross-sectional view showing a rechargeable lithium battery according to one or more embodiments of the present disclosure.

### DETAILED DESCRIPTION OF EMBODIMENTS

In order to sufficiently understand the configurations and aspects of the present disclosure, one or more embodiments of the disclosure will be described with reference to the accompanying drawings. It should be noted, however, that the disclosure is not limited to the following example embodiments, and may be implemented in one or more suitable forms. Rather, the example embodiments are provided only to illustrate the present disclosure and let those skilled in the art fully know the scope of the disclosure.

In the present disclosure, it will be understood that, if (e.g., when) an element is referred to as being on another element, the element may be directly on the other element or intervening elements may be present therebetween. In contrast, if (e.g., when) an element is referred to as being “directly on” another element, there are no intervening elements present. In the drawings, thicknesses of some components may be exaggerated for effectively explaining the technical contents. Like reference numerals refer to like elements throughout the present disclosure, and duplicative descriptions thereof may not be provided for conciseness.

Unless otherwise specially noted in the present disclosure, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”. In addition, unless otherwise specially noted, the phrase “A or B” or “A and/or B” or “A/B” may indicate “A but not B”, “B but not A”, and “A and B”. The terms “comprises/includes” and/or “comprising/including” used in the present disclosure do not exclude the presence or addition of one or more other components.

As used herein, the term “combination thereof” may refer to a mixture, a stack, a composite, a copolymer, an alloy, a blend, or a reaction product of the constituents.

In the present disclosure, unless otherwise separately defined, the term “substituted” may refer to that at least one hydrogen of a substituent or a compound is substituted by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

For example, in one or more embodiments, the term “substituted” may refer to that at least one hydrogen of a substituent or a compound is substituted by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In one or more embodiments, the term “substituted” may refer to that at least one hydrogen of a substituent or a compound is substituted by deuterium, a halogen, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen, a C1 to C5 alkyl group, a C6 to C18 aryl group, a C1 to C5 fluoroalkyl group, or a cyano group. In one or more embodiments, the term “substituted” may refer to that at least one hydrogen of a substituent or a compound is substituted by deuterium, a cyano group, a halogen, a methyl group, an ethyl group, a propyl group, a butyl group, a phenyl group, a biphenyl group, a terphenyl group, a trifluoromethyl group, or a naphthyl group.

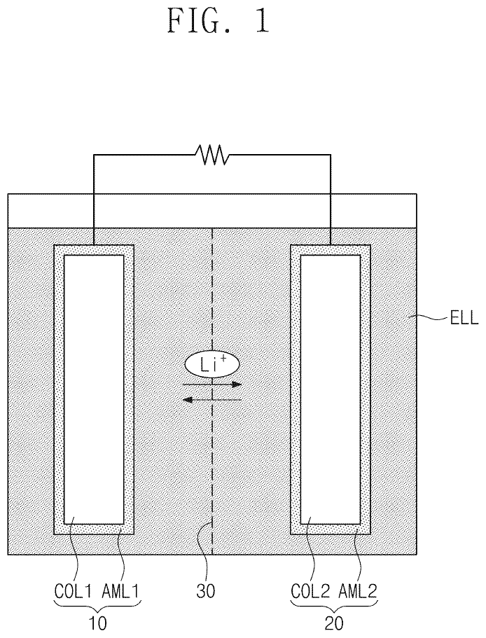

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. For example, the positive electrode 10, the negative electrode 20, and the separator 30 may be impregnated in (and/or with) the electrolyte ELL.

The electrolyte ELL may be a medium through which lithium ions are migrated and transferred between the positive electrode 10 and the negative electrode 20. In the electrolyte ELL, the lithium ions may move through the separator 30 toward one of (e.g., selected from among) the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material (e.g., in a form of particles) and may further include a binder and/or a conductive material (e.g., electron conductor).

For example, in one or more embodiments, the positive electrode 10 may further include an additive that may serve as a sacrificial positive electrode.

An amount of the positive electrode active material may be in a range of about 90 wt % to about 99.5 wt % based on 100 wt % of a total weight of the positive electrode active material layer AML1. Amounts of the binder and the conductive material may each be about 0.5 wt % to about 5 wt % based on 100 wt % of the total weight of the positive electrode active material layer AML1.

The binder may serve to improve attachment of positive electrode active material particles to each other and also to improve attachment of the positive electrode active material to the current collector COL1. The binder may include, for example, one or more selected from among polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but embodiments of the present disclosure are not limited thereto.

The conductive material (e.g., an electrically or electron conductive material) may be used to provide an electrode with conductivity, and any suitable conductive material without causing chemical change of a battery may be used as the conductive material to constitute the battery. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing one or more of (e.g., selected from among) copper, nickel, aluminum, and silver; a conductive polymer such as a polyphenylene derivative; and/or a (e.g., any suitable) mixture thereof.

In one or more embodiments, aluminum (Al) may be used as the current collector COL1, but embodiments of the present disclosure are not limited thereto.

### Positive Electrode Active Material

The positive electrode active material in the positive electrode active material layer AML1 may include a compound (e.g., lithiated intercalation compound) that may reversibly intercalate and deintercalate lithium. For example, in one or more embodiments, the positive electrode active material may include at least one kind of composite oxide including lithium and a metal that is selected from among cobalt, manganese, nickel, and/or a (e.g., any suitable) combination thereof.

The composite oxide may include a lithium transition metal composite oxide, for example, a lithium-nickel-based oxide, a lithium-cobalt-based oxide, a lithium-manganese-based oxide, a lithium-iron-phosphate-based compounds, a cobalt-free nickel-manganese-based oxide, and/or a (e.g., any suitable) combination thereof.

For example, in one or more embodiments, the positive electrode active material may include a compound represented by one selected from among chemical formulae: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0≤α≤2); LiₐNi_{1-b-c}Mn_{b}X_{c}O₂₋ₐDₐ (0.90≤a≤1.8, 0≤b≤0.5, 0≤c≤0.5, 0≤α≤2); LiₐNi_{b}Co_{c}L¹ₐGₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the foregoing chemical formulae, A may be nickel (Ni), cobalt (Co), manganese (Mn), and/or a (e.g., any suitable) combination thereof, X may be Al, Ni, Co, Mn, chromium (Cr), iron (Fe), Mg, strontium (Sr), V, a rare-earth element, and/or a (e.g., any suitable) combination thereof, D may be oxygen (O), fluorine (F), sulfur(S), phosphorous (P), and/or a (e.g., any suitable) combination thereof, G may be Al, Cr, Mn, Fe, Mg, lanthanum (La), cerium (Ce), Sr, V, and/or a (e.g., any suitable) combination thereof, and L¹ may be Mn, Al, and/or a (e.g., any suitable) combination thereof.

In one or more embodiments, the positive electrode active material may include an olivine-structured positive electrode active material. The positive electrode active material may include at least one selected from among compounds represented by Chemical Formulae 1 and 2.

Liₐ₁Feₓ₁B¹_{y1}PO_{4-b1} Chemical Formula 1

In Chemical Formula 1, 0.8≤a1≤1.2, 0.9≤x1≤1.1, 0.001≤y1≤0.05, and 0<b1≤0.05.

Liₐ₂Mn_{z2}Feₓ₂B¹_{y2}PO_{4-b2} Chemical Formula 2

In Chemical Formula 2, 0.8≤a2≤1.2, 0.5≤z2≤0.9, 0.1≤x2≤0.5, 0.001≤y2≤0.05, 0<b2≤0.05, and 0.9≤z2+x2≤1.2.

In Chemical Formula 1 and Chemical Formula 2, B¹ may be at least one element selected from among Ti, Mg, V, and Nb, and may be a dopant implanted in positive electrode active material particles.

Compared to other positive electrode active materials, the olivine-structured positive electrode active material may be cheap and may have excellent or suitable stability and lifespan characteristics. In addition, if (e.g., when) a subsequently described nitrile-based additive is used along with the olivine-based positive electrode active material, a rechargeable lithium battery may improve in lifespan and storage characteristics compared to using other positive electrode active materials. This effect may be caused by excellent or suitable reactivity of Fe element and CN group in olivine-based active materials.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material (e.g., in a form of particles) and may further include a binder and/or a conductive material (e.g., electron conductor).

For example, in one or more embodiments, the negative electrode active material layer AML2 may include a negative electrode active material of about 90 wt % to about 99 wt %, a binder of about 0.5 wt % to about 5 wt %, and a conductive material of about 0 wt % to about 5 wt %, based on 100 wt % of a total weight of the negative electrode active material layer.

The binder may serve to improve attachment of negative electrode active material particles to each other and also to improve attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include a styrene-butadiene rubber, a (meth)acrylated styrene-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

When an aqueous binder is used as the binder of the negative electrode, a cellulose-based compound capable of providing viscosity may further be included. The cellulose-based compound may include one or more selected from among carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material (e.g., electrically or electron conductive material) may be used to provide an electrode with conductivity, and any suitable conductive material without causing chemical change of a battery may be used as the conductive material to constitute the battery. For example, in one or more embodiments, the conductive material may include a carbon-based material such as natural graphite, artificial graphite, carbon black, acetylene black, Ketjen black, carbon fiber, carbon nano-fiber, and carbon nano-tube; a metal powder or metal fiber including one or more selected from among copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, or a transition metal oxide.

The material that may reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped (e.g., irregularly shaped), sheet-shaped, flake-shaped, sphere-shaped, or fiber-shaped natural graphite and/or artificial graphite, and the amorphous carbon may include soft carbon, hard carbon, mesophase pitch carbon, and/or calcined coke.

The lithium metal alloy may include an alloy of lithium and a metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material that may dope and de-dope lithium may include a Si-based negative electrode active material or a Sn-based negative electrode active material. The Si-based negative electrode active material may include silicon, a silicon-carbon composite, SiOₓ (0<x≤2), an Si-Q alloy (where Q is an alkali metal, an alkaline earth metal, a Group 13 element, a Group 14 element (except for Si), a Group 15 element, a Group 16 element, a transition metal, a rare-earth element, and/or a (e.g., any suitable) combination thereof), and/or a (e.g., any suitable) combination thereof. The Sn-based negative electrode active material may include Sn, SnOₖ (0<k≤2) (e.g., SnO₂), a Sn-based alloy, or a (e.g., any suitable) combination thereof.

The silicon-carbon composite may be a composite of silicon and amorphous carbon (e.g., in a form of particles). According to one or more embodiments, the silicon-carbon composite may have a structure in which the amorphous carbon is coated on a surface of each of silicon particles. For example, in one or more embodiments, the silicon-carbon composite may include a secondary particle (core) in which primary silicon particles are assembled, and an amorphous carbon coating layer (shell) on (e.g., positioned on) a surface of the secondary particle. The amorphous carbon may also be positioned between the primary silicon particles, and for example, the primary silicon particles may be coated with the amorphous carbon. The secondary particles may be present dispersed in an amorphous carbon matrix.

In one or more embodiments, the silicon-carbon composite may further include crystalline carbon. For example, the silicon-carbon composite may include a core including crystalline carbon and silicon particles and may also include an amorphous carbon coating layer positioned on a surface of the core.

In one or more embodiments, the Si-based negative electrode active material and/or the Sn-based negative electrode active material may be used in combination with a carbon-based negative electrode active material.

### Separator 30

Based on type or kind of the rechargeable lithium battery, the separator 30 may be present between the positive electrode 10 and the negative electrode 20. The separator 30 may include one or more selected from among polyethylene, polypropylene, and polyvinylidene fluoride, or may have a multi-layered separator thereof such as a polyethylene/polypropylene bi-layered separator, a polyethylene/polypropylene/polyethylene tri-layered separator, or a polypropylene/polyethylene/polypropylene tri-layered separator.

The separator 30 may include a porous substrate and a coating layer positioned on a surface (e.g., one surface or two opposite surfaces) of the porous substrate, and the coating layer may include an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, a glass fiber, and polytetrafluoroethylene (e.g., Teflon), or may be a copolymer or a mixture including two or more thereof.

The organic material may include a polyvinylidenefluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but embodiments of the present disclosure are not limited thereto.

In one or more embodiments, the organic material and the inorganic material may be present mixed in one coating layer or may be present as a stack of a coating layer including the organic material and a coating layer including an inorganic material.

### Electrolyte ELL

The electrolyte ELL for the rechargeable lithium battery may include a non-aqueous organic solvent and a lithium salt, and may further include an additive.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1.4-dioxolane; and/or sulfolanes.

The non-aqueous organic solvent may be used alone or in a mixture of two or more thereof.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery and plays a role in enabling a basic operation of the rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFBOP), and lithium bis(oxalato) borate (LiBOB)

### Rechargeable Lithium Battery

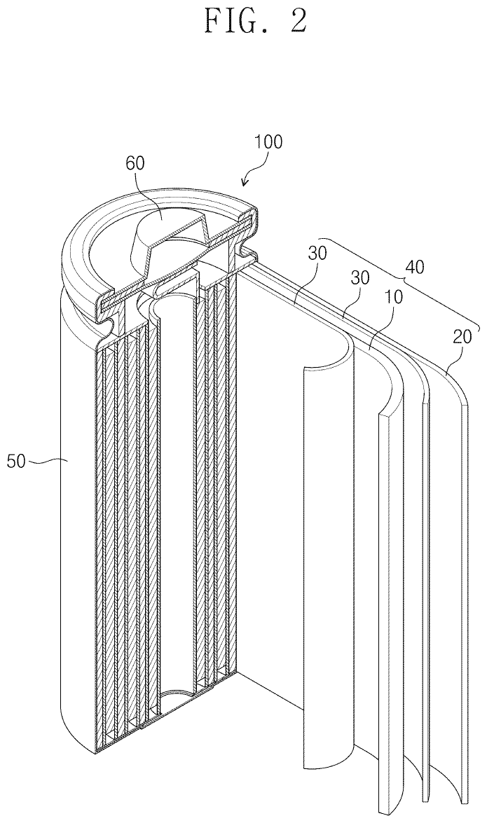

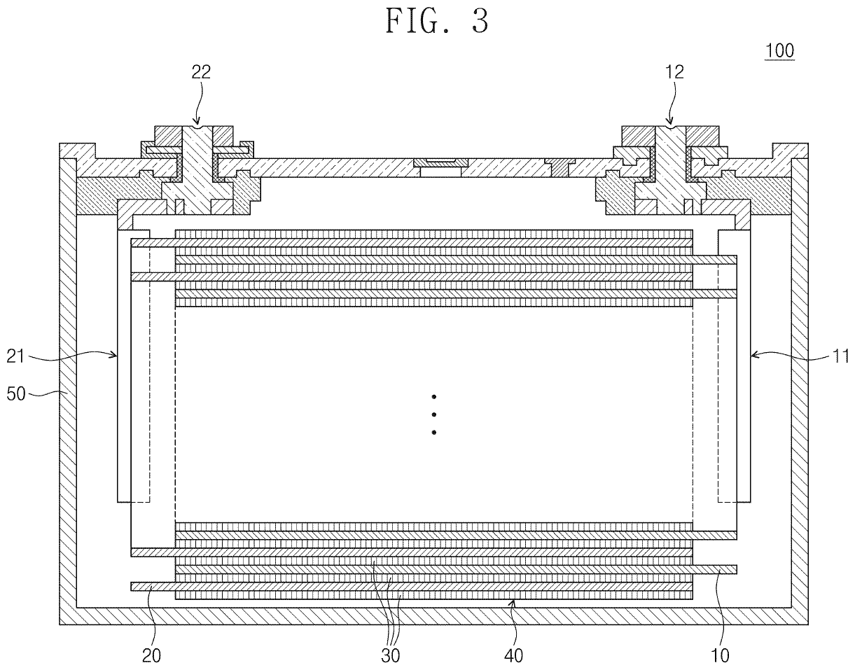

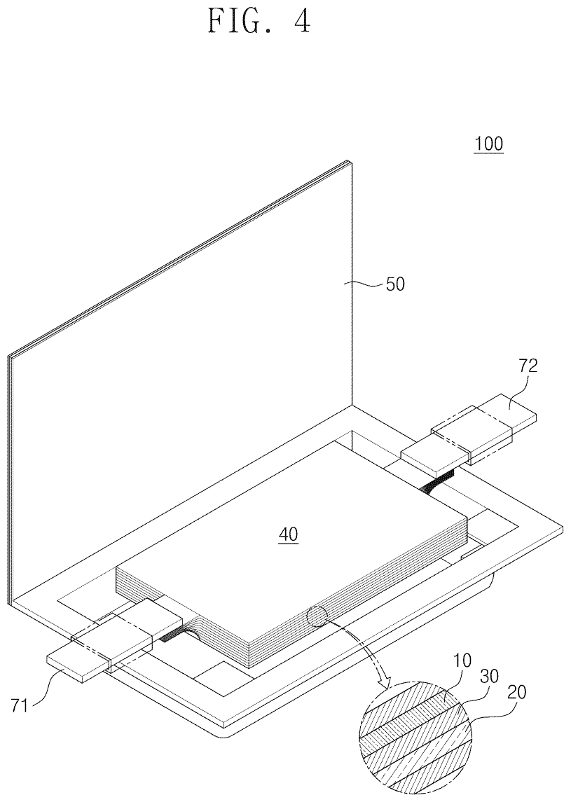

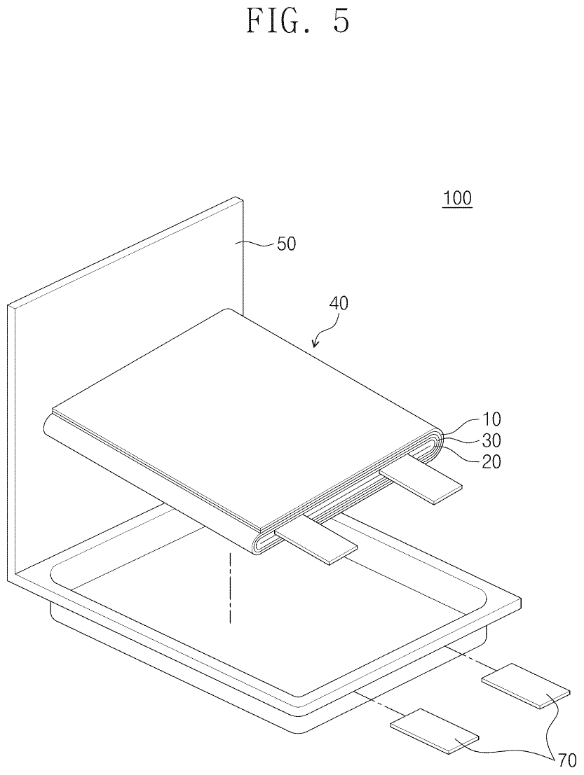

Based on the shape of a rechargeable lithium battery, the rechargeable lithium battery may be classified into cylindrical, prismatic, pouch, or coin types (kinds). In FIGS. 2 to 5 each illustrating a simplified diagram showing a rechargeable lithium battery according to one or more embodiments of the present disclosure, FIG. 2 shows a cylindrical battery, FIG. 3 shows a prismatic battery, and FIGS. 4 and 5 each show a pouch-type or kind battery. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. In some embodiments, the rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. In some embodiments, as shown in FIGS. 4 and 5, the rechargeable lithium battery 100 may include an electrode tab 70, or a positive electrode tab 71 and a negative electrode tab 72, which serves as an electrical path for externally inducing a current generated in the electrode assembly 40.

The following will describe in more detail an electrolyte for a rechargeable lithium battery according to one or more embodiments of the present disclosure.

According to one or more embodiments, an electrolyte for a rechargeable lithium battery may include a lithium salt, a non-aqueous organic solvent, and a nitrile-based additive. The nitrile-based additive may include at least one selected from among compounds represented by Chemical Formulae 3 to 5.

R—C≡N Chemical Formula 3

In Chemical Formula 3, R may be a substituted or unsubstituted C1 to C10 alkyl group.

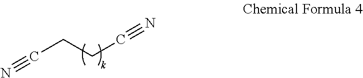

In Chemical Formula 4, k may be an integer of 0 to 10.

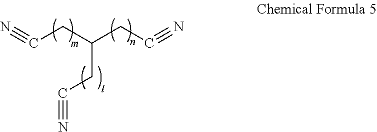

In Chemical Formula 5, l, m, and n may each independently be an integer of 0 to 10, and may be different integers from each other.

The nitrile-based compound may form a film on an electrode surface in an activation process or an initial charge/discharge process, thereby reducing a side reaction between an electrode and an electrolyte. When a stable film is formed on a surface of the negative electrode, reductive decomposition may be effectively suppressed or reduced during battery storage, particularly during high-temperature storage. Thus, during high-temperature storage, there may be an increase in battery resistance being suppressed or reduced and lifespan characteristics being improved.

In addition, the nitrile-based compound may suppress or reduce gas generation and lifespan reduction caused by dissolution of transition metal by forming a complex with the transition metal during its dissolution.

The compound represented by Chemical Formula 5, for example, 1,3,6-hexane tri-cyanide (1,3,6-HTCN), may possess three CN groups to form a plurality of coordination bonds. Moreover, hexane tri-cyanide (HTCN) may be coordinately bonded in the form of three-dimensionally around (e.g., surrounding) a metal ion to thereby form a stable coordination compound. It may thus be possible to effectively achieve a reduction in side reaction between the electrode active material and the electrolyte and a removal of dissolved transition metal.

The additive (e.g., the nitrile-based additive) may be included in an amount of about 0.01 wt % to about 5 wt %, about 0.05 wt % to about 5 wt %, about 0.05 wt % to about 4 wt %, about 0.1 wt % to about 4 wt %, or about 0.1 wt % to about 3 wt % relative to a total weight of 100 wt % of the electrolyte.

When the additive has an amount within the range above, the electrolyte may have appropriate or suitable viscosity, and may satisfy wettability to negative and positive electrodes. When the additive has an amount within the range above, the effect as a surfactant may be exhibited.

According to one or more embodiments of the present disclosure, the non-aqueous organic solvent may be a mixed solvent of ethylene carbonate (EC), ethylmethyl carbonate (EMC), and dimethyl carbonate (DMC).

In one or more embodiments, ethylene carbonate (EC), ethylmethyl carbonate (EMC), and dimethyl carbonate (DMC) may be mixed in a volume ratio of 1:a:b, where a may be in a range of about 1 to about 3, and b may be in a range of about 1 to about 5.

In one or more embodiments, the ethylene carbonate (EC) solvent may be included in an amount of about 5 vol % to about 30 vol %, about 10 vol % to about 30 vol %, or 10 vol % to about 20 vol % relative to a total volume of 100 vol % of the non-aqueous organic solvent. The ethylmethyl carbonate (EMC) solvent may be included in an amount of about 20 vol % to about 60 vol %, about 20 vol % to about 50 vol %, or about 30 vol % to about 50 vol % relative to the total volume of 100 vol % of the non-aqueous organic solvent. The dimethyl carbonate (DMC) solvent may be included in an amount of about 20 vol % to about 60 vol %, about 20 vol % to about 50 vol %, or about 30 vol % to about 50 vol % relative to the total volume of 100 vol % of the non-aqueous organic solvent.

In the electrolyte according to some embodiments of the present disclosure, the lithium salt may include LiPF₆.

The lithium salt may have a concentration of about 0.1 M to about 2.0 M. For example, in one or more embodiments, the lithium salt may have a concentration of equal to or greater than about 0.5 M or 1.0 M. The lithium salt may have a concentration of equal to or less than about 2.0 M, equal to or less than about 1.7 M, or equal to or less than about 1.5 M. In the disclosure, if (e.g., when) the lithium salt has a concentration of about 0.1 M to about 2.0 M, the electrolyte may appropriately or suitably maintain its conductivity and viscosity.

The following will describe Embodiments and Comparative Examples of the disclosure. The following Embodiments, however, are mere examples, and the disclosure is not limited to Embodiments discussed.

### EMBODIMENTS AND COMPARATIVE EXAMPLES

An electrolyte and a rechargeable lithium battery were each fabricated by the following method.

### Embodiment 1

### (1) Preparation of Electrolyte

1.5 M LiPF₆ was dissolved in a non-aqueous organic solvent including ethylene carbonate (EC), ethylmethyl carbonate (EMC), and dimethyl carbonate (DMC) mixed in a volume ratio of about 20:40:40, and 0.5 wt % of an additive was added to prepare an electrolyte.

A compound represented by Chemical Formula 5-1 was used as the additive.

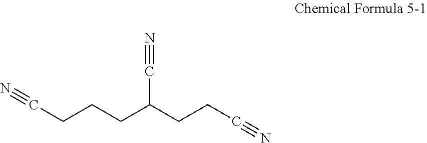 [SMILES: N#CCCCC(C#N)CCC#N]

### (2) Fabrication of Rechargeable Lithium Battery

LiFePO₄ (LFP) as a positive electrode active material, polyvinylidene fluoride as a binder, and carbon black as a conductive material were mixed in a weight ratio of 98:1:1, and the mixture was dispersed in N-methyl pyrrolidone to prepare a positive electrode active material slurry.

The positive electrode active material slurry was coated on an Al foil of 20 μm in thickness, dried at 100° C., and then pressed to manufacture a positive electrode.

Graphite as a negative electrode active material, a styrene-butadiene rubber binder, and carboxymethyl cellulose were mixed in a weight ratio of 98:1:1, and the mixture was dispersed in distilled water to prepare a negative electrode active material slurry.

The negative electrode active material slurry was coated on a Cu foil of 10 μm in thickness, dried at 100° C., and then pressed to manufacture a negative electrode.

The positive electrode, the negative electrode, and a polyethylene separator of 10 μm in thickness were assembled to manufacture an electrode assembly, and the electrolyte was introduced to fabricate a rechargeable lithium battery.

### Embodiment 2

An electrolyte and a rechargeable lithium battery were each fabricated by substantially the same method as that in Embodiment 1, except that a compound represented by Chemical Formula 4-1 was added at 0.5 wt % as the additive when the electrolyte was prepared.

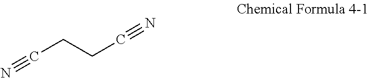

### Embodiment 3

An electrolyte and a rechargeable lithium battery were each fabricated by substantially the same method as that in Embodiment 1, except that a compound represented by Chemical Formula 3-1 was added at 0.5 wt % as the additive when the electrolyte was prepared.

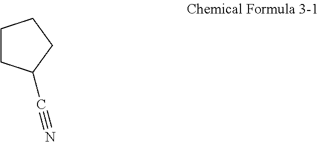

### Embodiment 4

An electrolyte and a rechargeable lithium battery were each fabricated by substantially the same method as that in Embodiment 1, except that a compound represented by Chemical Formula 3-2 was added at 0.5 wt % as the additive when the electrolyte was prepared.

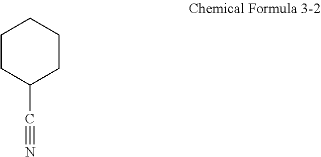

### Embodiment 5

An electrolyte and a rechargeable lithium battery were each fabricated by substantially the same method as that in Embodiment 1, except that a compound represented by Chemical Formula 3-3 was added at 0.5 wt % as the additive when the electrolyte was prepared.

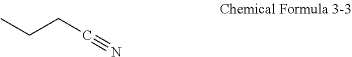

### Embodiment 6

An electrolyte and a rechargeable lithium battery were each fabricated by substantially the same method as that in Embodiment 1, except that the compound represented by Chemical Formula 5-1 was added at 0.1 wt % as the additive when the electrolyte was prepared.

### Embodiment 7

An electrolyte and a rechargeable lithium battery were each fabricated by substantially the same method as that in Embodiment 1, except that the compound represented by Chemical Formula 5-1 was added at 0.3 wt % as the additive when the electrolyte was prepared.

### Embodiment 8

An electrolyte and a rechargeable lithium battery were each fabricated by substantially the same method as that in Embodiment 1, except that the compound represented by Chemical Formula 5-1 was added at 1 wt % as the additive when the electrolyte was prepared.

### Embodiment 9

An electrolyte and a rechargeable lithium battery were each fabricated by substantially the same method as that in Embodiment 1, except that the compound represented by Chemical Formula 5-1 was added at 3 wt % as the additive when the electrolyte was prepared.

### Embodiment 10

An electrolyte and a rechargeable lithium battery were each fabricated by substantially the same method as that in Embodiment 1, except that the compound represented by Chemical Formula 5-1 was added at 5 wt % as the additive when the electrolyte was prepared.

### Embodiment 11

An electrolyte and a rechargeable lithium battery were each fabricated by substantially the same method as that in Embodiment 1, except that LiFe_{0.4}Mn_{0.6}PO₄ (LMFP) was used as the positive electrode active material when the rechargeable lithium battery was manufactured.

### Embodiment 12

An electrolyte and a rechargeable lithium battery were each fabricated by substantially the same method as that in Embodiment 6, except that LiFe_{0.4}Mn_{0.6}PO₄ was used as the positive electrode active material when the rechargeable lithium battery was manufactured.

### Embodiment 13

An electrolyte and a rechargeable lithium battery were each fabricated by substantially the same method as that in Embodiment 9, except that LiFe_{0.4}Mn_{0.6}PO₄ was used as the positive electrode active material when the rechargeable lithium battery was manufactured.

### Comparative Example 1

An electrolyte and a rechargeable lithium battery were each fabricated by substantially the same method as that in Embodiment 1, except that no additive is added when the electrolyte was prepared.

### Comparative Example 2

An electrolyte and a rechargeable lithium battery were each fabricated by substantially the same method as that in Embodiment 11, except that no additive is added when the electrolyte was prepared.

### Comparative Example 3

An electrolyte and a rechargeable lithium battery were each fabricated by substantially the same method as that in Embodiment 1, except that LiNi_{0.8}Co_{0.1}Al_{0.1}O₂ (NCA) was used as the positive electrode active material when the rechargeable lithium battery was manufactured.

### Comparative Example 4

An electrolyte and a rechargeable lithium battery were each fabricated by substantially the same method as that in Embodiment 1, except that LiNi_{0.7}Co_{0.2}Mn_{0.1}O₂ (NCM) was used as the positive electrode active material when the rechargeable lithium battery was manufactured.

### EVALUATION EXAMPLE

An electrolyte and a rechargeable lithium battery were each evaluated by the following method.

### Evaluation 1: Lifespan Characteristics at Room Temperature

Each of rechargeable lithium batteries of Embodiments 1 to 13 and Comparative Examples 1 to 4 was continuously charged and discharged for 800 cycles under the conditions of 0.5 C charge and 0.5 C discharge at room temperature (25° C.), and then a capacity retention rate and a resistance increase rate after 800 cycles were evaluated. The evaluation results were listed in Tables 1 and 2.

The capacity retention rate was calculated according to Equation 1, and the resistance increase rate was calculated according to Equation 2.

$$800 - cycle capacity retention rate ( \% ) = ( discharge capacity at {800}^{th} cycle / discharge capacity at {1}^{st} cycle ) \times 100 \qquad [ Equation 1 ]$$

$$DC - IR increase rate ( \% ) = ( DC - IR ( m Ω ) at {800}^{th} cycle / DC - IR ( m Ω ) at {1}^{st} cycle ) \times 100 \qquad [ Equation 2 ]$$

TABLE 1

| | Positive | | Amount | Capacity | |
|---|---|---|---|---|---|
| | electrode | | of | retention | DC-IR |
| | active | Kind of | additive | rate | increase |
| | material | additive | (wt %) | (%) | rate (%) |
| Comparative | LFP | — | 0 | 62.4 | 127.2 |
| Example 1 | | | | | |
| Embodiment | LFP | Chemical | 0.5 | 90.2 | 113.3 |
| 1 | | Formula 5-1 | | | |
| Embodiment | LFP | Chemical | 0.5 | 88.9 | 115.4 |
| 2 | | Formula 4-1 | | | |
| Embodiment | LFP | Chemical | 0.5 | 81.8 | 116.3 |
| 3 | | Formula 3-1 | | | |
| Embodiment | LFP | Chemical | 0.5 | 79.4 | 118.1 |
| 4 | | Formula 3-2 | | | |
| Embodiment | LFP | Chemical | 0.5 | 85.4 | 117.1 |
| 5 | | Formula 3-3 | | | |
| Embodiment | LFP | Chemical | 0.1 | 71.4 | 124.7 |
| 6 | | Formula 5-1 | | | |
| Embodiment | LFP | Chemical | 0.3 | 80.8 | 118.7 |
| 7 | | Formula 5-1 | | | |
| Embodiment | LFP | Chemical | 1 | 89.7 | 113.7 |
| 8 | | Formula 5-1 | | | |
| Embodiment | LFP | Chemical | 3 | 88.4 | 115.6 |
| 9 | | Formula 5-1 | | | |
| Embodiment | LFP | Chemical | 5 | 80.5 | 120.4 |
| 10 | | Formula 5-1 | | | |
| Comparative | LMFP | — | 0 | 65.3 | 155.1 |
| Example 2 | | | | | |
| Embodiment | LMFP | Chemical | 0.5 | 84.7 | 134.3 |
| 11 | | Formula 5-1 | | | |
| Embodiment | LMFP | Chemical | 0.1 | 80.5 | 137.5 |
| 12 | | Formula 5-1 | | | |
| Embodiment | LMFP | Chemical | 3 | 89.4 | 131.7 |
| 13 | | Formula 5-1 | | | |

Referring to Table 1, it may be ascertained that, compared to the rechargeable lithium batteries according to Comparative Examples 1 and 2, the rechargeable lithium batteries according to Embodiments 1 to 13 each have its high capacity retention rate and low DC-IR increase rate. In particular, it may be ascertained that after 800 cycles the rechargeable lithium batteries according to Embodiments 1 and 8 each have its high capacity retention rate up to 90% and low resistance increase rate of 125% or less.

TABLE 2

| | Positive | | Amount | Capacity | |
|---|---|---|---|---|---|
| | electrode | | of | retention | DC-IR |
| | active | Kind of | additive | rate | increase |
| | material | additive | (wt %) | (%) | rate (%) |
| Embodiment | LFP | Chemical | 0.5 | 90.2 | 113.3 |
| 1 | | Formula 5-1 | | | |
| Embodiment | LMFP | Chemical | 0.5 | 84.7 | 134.3 |
| 11 | | Formula 5-1 | | | |
| Comparative | LFP | — | 0 | 62.4 | 127.2 |
| Example 1 | | | | | |
| Comparative | LMFP | — | 0 | 65.3 | 155.1 |
| Example 2 | | | | | |
| Comparative | NCA | Chemical | 0.5 | 66.9 | 148.5 |
| Example 3 | | Formula 5-1 | | | |
| Comparative | NCM | Chemical | 0.5 | 69.3 | 142.2 |
| Example 4 | | Formula 5-1 | | | |

Referring to Table 2, it may be ascertained that the capacity retention rate is greater in each of the rechargeable lithium batteries of Embodiments 1 and 11, each of which uses the olivine-based positive electrode active material (LFP or LMFP) and the electrolyte to which the additive of Chemical Formula 5-1 is added, than that in the rechargeable lithium batteries of Comparative Examples 1 and 2 in which no additive is added.

In addition, as the DC-IR increase rate of Embodiment 1 is less than that of Comparative Example 1, and as the DC-IR increase rate of Embodiment 11 is less than that of Comparative Example 2, it may be ascertained that there is a significant suppression of resistance increase when using the electrolyte including the additive of Chemical Formula 5-1.

Referring back to Table 2, it may be ascertained that the capacity retention rate is greater in each of the rechargeable lithium batteries of Embodiments 1 and 11, each of which uses the olivine-based positive electrode active material (LFP or LMFP) and the electrolyte including the additive of Chemical Formula 5-1, than that in the rechargeable lithium batteries of Comparative Examples 3 and 4, each of which uses the nickel-based positive electrode active material (NCA or NCM) and the electrolyte including the additive of Chemical Formula 5-1.

Moreover, as the DC-IR increase rate of each of Embodiments 1 and 11 is less than that of Comparative Examples 3 and 4, it may be ascertained that Embodiments 1 and 11 each have a superior effect of resistance increase suppression. Accordingly, when the additive of the present disclosure is used along with the olivine-based positive electrode active material, it may maximize or increase an improvement in lifespan and storage characteristics of the rechargeable lithium battery.

### Evaluation 2: Storage Characteristics at High Temperature

Each of the rechargeable lithium batteries of Embodiments 1 to 13 and Comparative Examples 1 to 4 was charged to SOC 100%, and then was left at 60° C. for 60 days. Afterwards, capacity retention rates and resistance increase rates of the batteries were measured and listed in Tables 3 and 4.

The capacity retention rate was calculated according to Equation 3, and the resistance increase rate was calculated according to Equation 4.

$$Capacity retention rate ( \% ) = ( discharge capacity after 60 days / discharge capacity immediately before storage ) \times 100 \qquad [ Equation 3 ]$$

$$DC - IR increase rate = ( DC - IR ( m Ω ) after 60 days / DC - IR ( m Ω ) immediately before storage ) \times 100 \qquad [ Equation 4 ]$$

TABLE 3

| | Positive | | Amount | Capacity | |
|---|---|---|---|---|---|
| | electrode | | of | retention | DC-IR |
| | active | Kind of | additive | rate | increase |
| | material | additive | (wt %) | (%) | rate (%) |
| Comparative | LFP | — | 0 | 60.1 | 135.1 |
| Example 1 | | | | | |
| Embodiment | LFP | Chemical | 0.5 | 92.5 | 114.7 |
| 1 | | Formula 5-1 | | | |
| Embodiment | LFP | Chemical | 0.5 | 91.0 | 116.8 |
| 2 | | Formula 4-1 | | | |
| Embodiment | LFP | Chemical | 0.5 | 87.4 | 120.0 |
| 3 | | Formula 3-1 | | | |
| Embodiment | LFP | Chemical | 0.5 | 86.4 | 122.2 |
| 4 | | Formula 3-2 | | | |
| Embodiment | LFP | Chemical | 0.5 | 88.5 | 121.4 |
| 5 | | Formula 3-3 | | | |
| Embodiment | LFP | Chemical | 0.1 | 69.5 | 130.8 |
| 6 | | Formula 5-1 | | | |
| Embodiment | LFP | Chemical | 0.3 | 83.4 | 120.9 |
| 7 | | Formula 5-1 | | | |
| Embodiment | LFP | Chemical | 1 | 92.0 | 115.2 |
| 8 | | Formula 5-1 | | | |
| Embodiment | LFP | Chemical | 3 | 90.7 | 116.9 |
| 9 | | Formula 5-1 | | | |
| Embodiment | LFP | Chemical | 5 | 84.7 | 122.3 |
| 10 | | Formula 5-1 | | | |
| Comparative | LMFP | — | 0 | 63.1 | 157.7 |
| Example 2 | | | | | |
| Embodiment | LMFP | Chemical | 0.5 | 89.1 | 139.9 |
| 11 | | Formula 5-1 | | | |
| Embodiment | LMFP | Chemical | 0.1 | 78.4 | 144.2 |
| 12 | | Formula 5-1 | | | |
| Embodiment | LMFP | Chemical | 3 | 87.8 | 141.0 |
| 13 | | Formula 5-1 | | | |

Referring to Table 3, it may be ascertained that, compared to the rechargeable lithium batteries according to Comparative Examples 1 and 2 in which no additive is added, each of the rechargeable lithium batteries according to Embodiments 1 to 13 in which the nitrile-based additive is added has its large high-temperature capacity retention rate and small high-temperature DC-IR increase rate. In particular, it may be ascertained that, when the rechargeable lithium batteries according to Embodiments 1 and 8 were left at 60° C. for 60 days, each of the rechargeable lithium batteries has its high capacity retention rates up to 92% and low resistance increase rate of 131% or less.

TABLE 4

| | Positive | | | Capacity | |
|---|---|---|---|---|---|
| | electrode | | Amount of | retention | DC-IR |
| | active | Kind of | additive | rate | increase |
| | material | additive | (wt %) | (%) | rate (%) |
| Embodiment | LFP | Chemical | 0.5 | 90.2 | 113.3 |
| 1 | | Formula 5-1 | | | |
| Embodiment | LMFP | Chemical | 0.5 | 89.1 | 139.9 |
| 11 | | Formula 5-1 | | | |
| Comparative | LFP | — | 0 | 60.1 | 135.1 |
| Example 1 | | | | | |
| Comparative | LMFP | — | 0 | 63.1 | 157.7 |
| Example 2 | | | | | |
| Comparative | NCA | Chemical | 0.5 | 65.1 | 142.7 |
| Example 3 | | Formula 5-1 | | | |
| Comparative | NCM | Chemical | 0.5 | 67.0 | 144.4 |
| Example 4 | | Formula 5-1 | | | |

Referring to Table 4, it may be ascertained that the capacity retention rate is greater in each of the rechargeable lithium batteries of Embodiments 1 and 11, each of which uses the olivine-based positive electrode active material (LFP or LMFP) and the electrolyte to which the electrolyte of Chemical Formula 5-1 is added, than that in the rechargeable lithium batteries of Comparative Examples 1 and 2 in which no additive is added.

In addition, as the high-temperature DC-IR increase rate of Embodiment 1 is less than that of Comparative Example 1, and as the high-temperature DC-IR increase rate of Embodiment 11 is less than that of Comparative Example 2, it may be ascertained that there is a significant suppression of high-temperature resistance increase when using the electrolyte including the additive of Chemical Formula 5-1.

Referring back to Table 4, it may be ascertained that the capacity retention rate is greater in each of the rechargeable lithium batteries of Embodiments 1 and 11, each of which uses the olivine-based positive electrode active material (LFP or LMFP) and the electrolyte including the additive of Chemical Formula 5-1, than that in the rechargeable lithium batteries of Comparative Examples 3 and 4, each of which uses the nickel-based positive electrode active material (NCA or NCM) and the electrolyte including the additive of Chemical Formula 5-1.

Moreover, as the high-temperature DC-IR increase rate of each of Embodiments 1 and 11 is less than that of Comparative Examples 3 and 4, it may be ascertained that Embodiments 1 and 11 each have a superior effect of suppression of high-temperature resistance increase. Accordingly, when the additive of the present disclosure is used along with the olivine-based active material, it may maximize or increase an improvement in high-temperature lifespan and high-temperature storage characteristics of the rechargeable lithium battery.

In a rechargeable lithium battery according to one or more embodiments, lifespan characteristics may be improved, and a battery resistance increase may be suppressed or reduced at high-temperature storage.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present disclosure and unless otherwise defined, the terms “use,” “using,” and “used” may be considered synonymous with the terms “utilize,” “utilizing,” and “utilized,” respectively.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While the present disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims and equivalents thereof, and therefore the aforementioned embodiments should be understood to be exemplarily but not limiting this disclosure in any way.

What is claimed is:

1. A rechargeable lithium battery, comprising:
a positive electrode that comprises a positive electrode active material;
a negative electrode that comprises a negative electrode active material; and
an electrolyte,
wherein the electrolyte comprises a nitrile-based additive, and
wherein the positive electrode active material comprises at least one selected from among compounds represented by Chemical Formula 1 and Chemical Formula 2,
Liₐ₁Feₓ₁B¹_{y1}PO_{4-b1}, Chemical Formula 1
in Chemical Formula 1, 0.8≤a1≤1.2, 0.9≤x1≤1.1, 0.001≤y1≤0.05, and 0<b1≤0.05,
Liₐ₂Mn_{z2}Feₓ₂B¹_{y2}PO_{4-b2}, Chemical Formula 2
in Chemical Formula 2, 0.8≤a2≤1.2, 0.5≤z2≤0.9, 0.1≤x2≤0.5, 0.001≤y2≤0.05, 0<b2≤0.05, and 0.9≤z2+x2≤1.2, and
in Chemical Formula 1 and Chemical Formula 2, B1 being at least one element selected from among Ti, Mg, V, and Nb.

2. The rechargeable lithium battery as claimed in claim 1, wherein B¹ is Ti.

3. The rechargeable lithium battery as claimed in claim 1, wherein the nitrile-based additive comprises at least one selected from among compounds represented by Chemical Formula 3, Chemical Formula 4, and Chemical Formula 5,
R—C≡N Chemical Formula 3
in Chemical Formula 3, R being a substituted or unsubstituted C1 to C10 alkyl group, 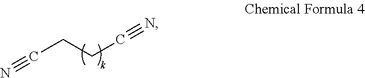
in Chemical Formula 4, k being an integer of 0 to 10, and 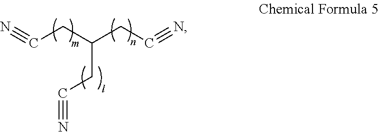
in Chemical Formula 5, l, m, and n being each independently an integer of 0 to 10.

4. The rechargeable lithium battery as claimed in claim 3, wherein l, m, and n are different integers from each other.

5. The rechargeable lithium battery as claimed in claim 1, wherein the nitrile-based additive comprises at least one selected from among 1,3,6-hexane tri-cyanide and 1,2,6-hexane tri-cyanide.

6. The rechargeable lithium battery as claimed in claim 1, wherein the nitrile-based additive is in an amount of about 0.01 wt % to about 5 wt % relative to a total weight of 100 wt % of the electrolyte.

7. The rechargeable lithium battery as claimed in claim 1, wherein the electrolyte further comprises a non-aqueous organic solvent and a lithium salt.

8. The rechargeable lithium battery as claimed in claim 7, wherein the non-aqueous organic solvent comprises a carbonate-based solvent.

9. The rechargeable lithium battery as claimed in claim 8, wherein the carbonate-based solvent comprises ethylene carbonate, ethylmethyl carbonate, and dimethyl carbonate.

10. The rechargeable lithium battery as claimed in claim 9, wherein ethylene carbonate, ethylmethyl carbonate, and dimethyl carbonate have a volume ratio of 1:a:b,
wherein a is about 1 to about 3, and
wherein b is about 1 to about 5.

11. The rechargeable lithium battery as claimed in claim 7, wherein the lithium salt is LiPF₆.

12. The rechargeable lithium battery as claimed in claim 7, wherein a concentration of the lithium salt is in a range of about 0.1 M to about 2.0 M.

13. The rechargeable lithium battery as claimed in claim 1, wherein the negative electrode active material comprises a carbon-based negative electrode active material, a Si-based negative electrode active material, a Sn-based negative electrode active material, or a combination thereof.

14. The rechargeable lithium battery as claimed in claim 1, wherein the negative electrode further comprise a solid electrolyte interface layer on a surface of the negative electrode.
